(19) United States
(12) Patent Application Publication
(10) Pub. No.: US 2001/0038426 A1
(43) Pub. Date: Nov. 8, 2001

(54) Liquid crystal display screen comprising a fluorescent front plate

(76) Inventors: Helmut Bechtel, Roetgen (DE); Hans Nikol, Aachen (DE); Cornelis Ronda, Aachen (DE)

Correspondence Address: Jack E. Haken, U.S. PHILLIPS CORPORATION, Intellectual Property Department, 580 White Plains Road, Tarrytown, NY, 10591, US

(21) Appl. No.: 09/759,185

(22) Filed: Jan. 12, 2001

(30) Foreign Application Priority Data
Jan. 14, 2000 (DE) 10001189.6

(51) Int. Cl. G02F 1/1335

(52) U.S. Cl. 349/71

(57) ABSTRACT

A liquid crystal display screen provided with a liquid crystal layer, two parallel transparent substrates by which the liquid crystal layer is flanked, a means for influencing the transmission state of the liquid crystal layer, a blue-emitting radiation source for radiation with a maximum emission at a wavelength of 400<λ₁<450 nm at the side of the first substrate, and a first phosphor layer comprising at least one phosphor, which phosphor layer is situated on the second substrate.

The invention relates to a liquid crystal display screen provided with a liquid crystal layer, two parallel transparent substrates by which the liquid crystal layer is flanked, a means to influence the transmission state of the liquid crystal layer, a radiation source at the side of the first substrate and a phosphor layer, comprising at least one phosphor, which phosphor layer is situated on the second substrate.

In liquid crystal display screens, use is made of the fact that by applying an electric field, the molecular orientation of several classes of liquid crystals can be controlled in such a manner that extraneous, incident, linearly polarized light is influenced in its direction of polarization. The different classes of liquid crystals include nematic, cholesteric and different types of smectic phases, which are each characterized by a different spatial arrangement of the molecules. For example, the widely used TN liquid crystal display screens (TN=twisted nematic) comprise nematic liquid crystals.

A conventional TN liquid crystal display screen is customarily made up of two glass plates whose inner sides are coated with a transparent electrode of indium tin oxide (ITO). A layer containing the liquid crystals is sandwiched between said glass plates. A 90° rotated edge orientation between the two plates is imposed on the nematic liquid crystal molecules by orientation layers situated on the glass plate. As a result, a 90° helix arises in the liquid crystal layer. Crossed polarizers on the outer surfaces of the glass plates and a two-dimensional backlighting complete the display screen. As long as no electric voltage is applied to the two ITO electrodes, the light originating from the backlighting, which is linearly polarized by the first polarizer, can follow the rotation through 90 degrees of the liquid crystal molecules and, subsequently, pass through the second polarizer; the display screen appears transparent. If a sufficiently high voltage is applied, the electric anisotropy of the liquid crystal molecules causes the helix to be removed and the direction of polarization of the polarized light remains uninfluenced. The polarized light cannot pass through the second polarizer, and the cell appears dark.

A complete picture on a screen is composed of a plurality of individual pixels. which are each driven via a matrix. In conventional liquid crystal color display screens a colored picture is formed by mosaic color filters, which are printed onto the front glass plate. The transmitted light from each pixel causes either the colors red or green or blue to light up.

A drawback of liquid crystal color display screens comprising color filters resides in that the display screen can only be looked at from specific viewing angles, and the color saturation, luminous intensity and brightness are clearly inferior as compared to CRT display screens.

Liquid crystal color display screens comprising a phosphor layer have a higher luminous intensity and a larger viewing angle. For example, U.S. Pat. No. 4,822,144 discloses a liquid crystal color display screen which is operated in the transmission mode and is based on a combination of liquid crystal switching elements and a phosphor layer, said phosphor layer being excited by a UV light source, and the brightness of the display screen being increased by an interference filter between the light source and the phosphor layer. The phosphor layer and the UV source may be situated at two remote sides of the liquid crystal switching elements. The UV source may be a mercury high-pressure lamp, which emits light with a maximum emission in the range between 360 and 380 nm, or a mercury low-pressure lamp which emits light with a maximum emission at 185.0 and 253.7 nm.

Backlighting using a mercury high-pressure lamp having a maximum emission at wavelengths between 360 and 380 nm has the drawback that, apart from short-wave light, also light of substantial intensity is emitted at 408, 435 and 546 nm. This leads to an incomplete division into the three primary colors red, green and blue in the phosphors, and to chromatic aberration of the color picture produced on the display screen.

On the other hand, backlighting using a mercury low-pressure lamp having a maximum emission at a wavelength of 185.0 and 253.7 nm, has the drawback that light of this wavelength is absorbed in the liquid crystal, leading to photochemical reactions in the liquid crystal, which may lead to its destruction in the course of time.

Therefore, it is an object of the invention to provide a liquid crystal display screen which yields a color-pure picture and has a long service life.

In accordance with the invention, this object is achieved by a liquid crystal display screen provided with a liquid crystal layer, two parallel transparent substrates by which the liquid crystal layer is flanked, a means for influencing the transmission state of the liquid crystal layer, a blue-emitting radiation source for radiation with a maximum emission at a wavelength of 400<λ₁<450 nm at the side of the first substrate, and a first phosphor layer comprising at least one phosphor, which phosphor layer is situated on the second substrate.

By using a blue-emitting radiation source instead of an UV-emitting radiation source, photochemical reactions between the radiation from the backlighting and the liquid crystal layer are precluded. In addition, for the components of the liquid crystal display screen use can be made of cheaper materials, which must be transparent to visible light but nontransparent to UV light.

In accordance with a preferred embodiment of the invention, the blue-emitting radiation source comprises a fluorescent lamp having a blue-emitting phosphor layer.

It may alternatively be preferred that the blue radiation source comprises a blue-emitting light emitting diode.

In a modification in accordance with the invention, the first phosphor layer may comprise a red phosphor, a green phosphor and a blue color filter.

It is preferred that the first phosphor layer comprises o-(6-diethylamino-3-diethylimino-3H-xanthene-9-yl)benzoic acid for the red phosphor, 3-(2′-benzothiazolyl)-7-diethylaminocoumarin for the green phosphor and CoAl₂O₄ for the blue color filter.

In a further modification in accordance with the invention, a second phosphor layer may be arranged between the liquid crystal layer and the first phosphor layer. Such a second phosphor layer may also act as a color-conversion layer.

These and other aspects of the invention will be apparent from and elucidated with reference to the embodiment(s) described hereinafter.

In the drawings:

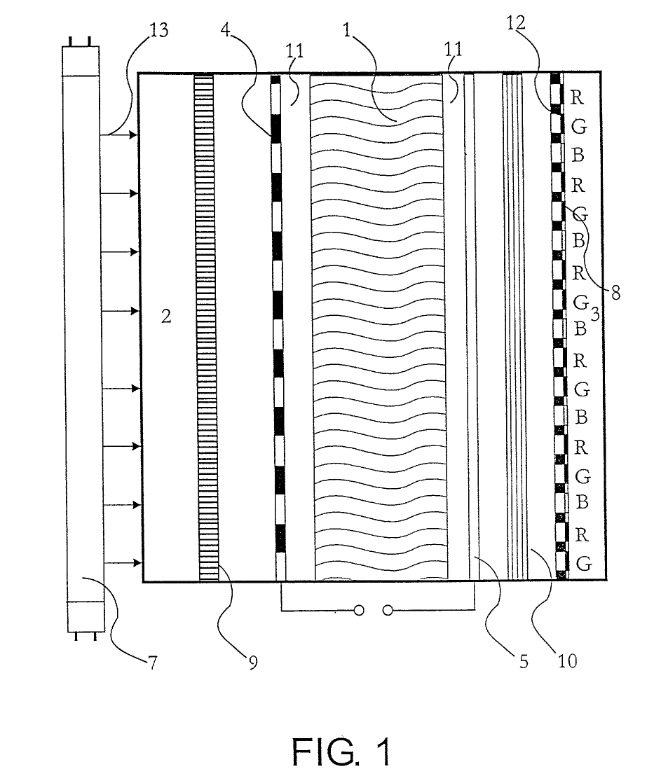

FIG. 1 is a cross-sectional view of a liquid crystal display screen, in accordance with an embodiment of the invention, comprising a phosphor layer having individual pixels.

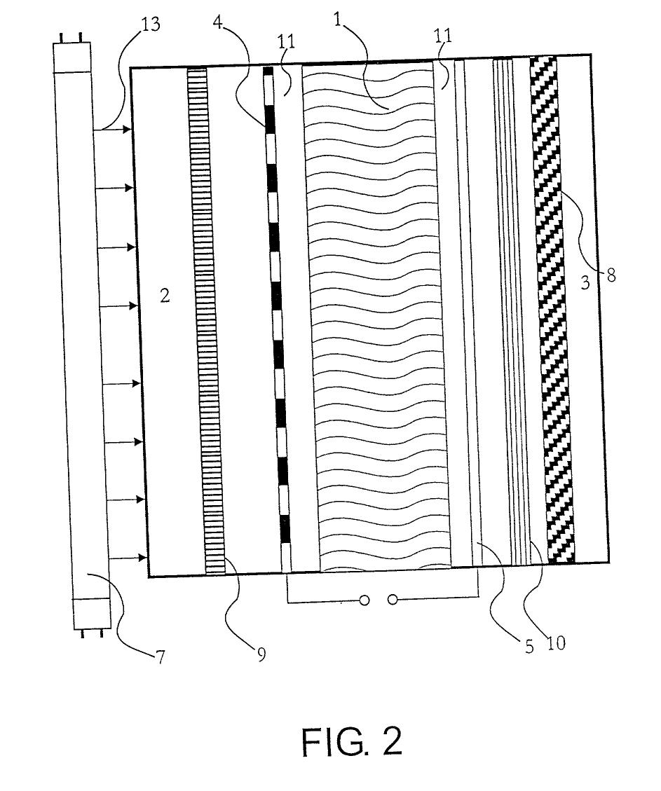

FIG. 2 is a cross-sectional view of a liquid crystal display screen, in accordance with an embodiment of the invention, comprising a continuous phosphor layer.

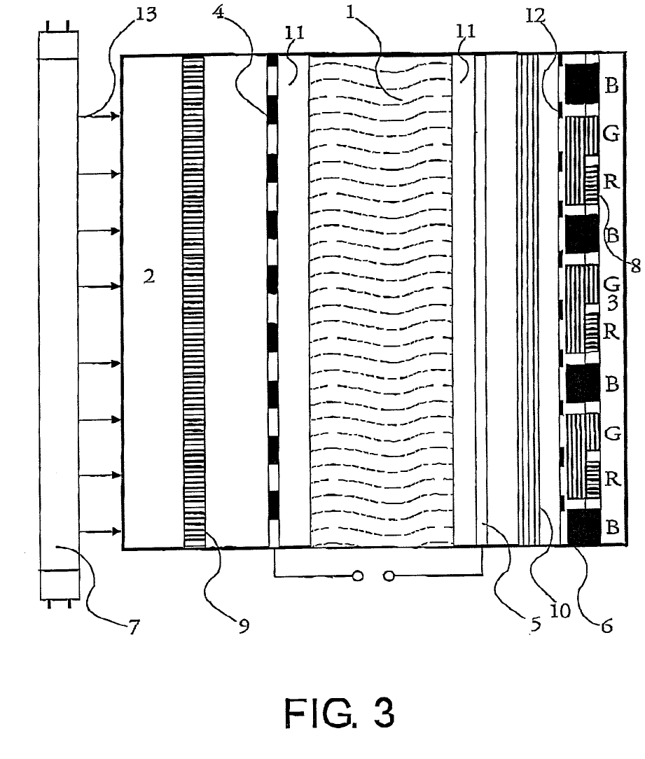

FIG. 3 is a cross-sectional view of a liquid crystal display screen, in accordance with an embodiment of the invention, comprising two phosphor layers having individual pixels.

A liquid crystal display screen in accordance with the invention comprises a liquid crystal layer 1, two parallel transparent substrates 2 and 3) by which the liquid crystal layer 1 is flanked, a means for influencing the transmission state of the liquid crystal layer 4 and 5, a blue-emitting radiation source 7 for emitting radiation having a maximum emission at a wavelength of 400<λ₁<450 nm at the side of the first substrate, and a first phosphor layer 8 comprising at least one phosphor, which phosphor layer is situated on the second substrate.

The two substrates jointly form the basic body of the liquid crystal display screen. They are transparent to visible light. In accordance with an embodiment of the invention, both substrates may be made of glass or a transparent synthetic resin. The substrates are sealed at their periphery by means of a packing. The substrates and the packing enclose a space filled with the liquid crystal layer.

For the liquid crystal layer use can be made of different liquid crystal materials. For example, a “twisted nematic” material with a 90° twist can be used for a TN-LCD, or a “supertwisted nematic” material with a twist in the range from 180 to 270° can be used for a STN-LCD, or a birefringent material with a 270° twist (“supertwisted birefringence”) can be used for a SBE-LCD. Also ferroelectric, smectic and cholesteric liquid crystal materials may be suitable.

As regards the means capable of influencing the transmission state of the liquid crystal layer, a distinction is made between a passive matrix drive and an active matrix drive. In liquid-crystal display screens with an active matrix (AM-LCD), each pixel is associated with a switch of its own, which may consist of a thin-film transistor (TFT) or a thin-film diode (TFD). Active-matrix drive also includes driving using plasma discharges in accordance with the PALC technology, which can suitably be used for the liquid crystal display screens in accordance with the invention. Liquid crystal display screens with an active matrix demonstrate, all in all, an improved contrast, a higher color saturation and a smaller rise time.

At present, the majority of the liquid crystal display screens produced worldwide are driven by a passive matrix. As shown in FIG. 1, the surfaces of the substrates, which are in contact with the liquid crystal layer, are coated for this purpose with arrays of transparent, strip-shaped electrodes 4 and 5, which cross each other at right angles so as to form a matrix of switching points. The electrodes may be made, for example, of ITO. The electrodes are covered with an orientation layer II of obliquely evaporated silicon dioxide. Furthermore, a polarizer 9 is arranged on the first substrate, and an analyzer 10 is arranged on the second substrate.

For the radiation source, use is made of a mercury low-pressure lamp 7 comprising a phosphor layer, which only contains a blue-emitting phosphor, for example BaMgAl₁₀O₁₇:Eu, and which emits blue light having a wavelength of 447 nm, which mercury low-pressure lamp is arranged at the side of the substrate 2. Alternatively, use can be made of a blue-emitting UV diode as the radiation source.

A collimator may be provided between the radiation source and the means for influencing the transmission state of the liquid crystal layer, which collimator serves to improve the contrast, the color purity and the efficiency of the liquid crystal display screen.

The front substrate 3 situated on the side facing the viewer is provided with a first phosphor layer on the surface adjoining the liquid crystal layer or on the outer surface.

The first phosphor layer is composed of a mosaic pattern of red, green and blue pixels comprising a red and a green phosphor and a blue scattering pigment which are each associated with a switching point and emit red and, green or transmit blue light when they are excited by blue light emitted by the backlighting.

The materials which can suitably be used as phosphors must absorb the incident, monochrome, blue radiation, emit in a suitable wavelength range and attain a high fluorescence quantum yield. Materials which can particularly suitably be used are the inorganic calciumsulphide phosphors: CaS:Eu as the red-emitting phosphor, and CaS:Ce as the green-emitting phosphor. For the blue, scattering pigment use can suitably be made of CoAl₂O₄.

Other phosphors which can be used to efficiently generate visible, colored light from blue light are organic phosphors: o-(6-diethylamino-3-diethylimino-3H-xanthene-9-yl)benzoic acid for the red range, and 3-(2′-benzothiazolyl)-7-diethylaminocoumarin for the green range.

Use can be made of a single phosphor layer or a sandwich arrangement of two phosphor layers.

In the first phosphor layer, the pixels can be provided in a customary manner as points or stripes for the color triad of red, green, blue.

If the liquid crystal display screen is provided with a second phosphor layer, said second phosphor layer may comprise, as shown in FIG. 3, green pixels situated above the green and the red pixels of the first phosphor layer, which green pixels of the second phosphor layer serve as color transformers for the radiation from the backlighting. For the red-emitting pixels of the first layer, use is made of o-(6-diethylamino-3-diethylimino-3H-xanthene-9-yl)benzoic acid as the red phosphor for the green luminous dots in the first and the second layer use is made of 3-(2′-benzothiazolyl)-7-diethylaminocoumarin as the green phosphor. For the blue luminous dots of the first layer, use is made of CoAl₂O₄ as the blue color filter. The green fluorescent light from the 3-(2′-benzothiazolyl)-7-diethylaminocoumarin is transformed to red fluorescent light by o-(6-diethylamino-3-diethylimino-3H-xanthene-9-yl)benzoic acid. The excitation by the long-wave fluorescent light from the green phosphor precludes a photoreaction in the red phosphor and extends its service life.

As shown in FIG. 2, for a monochrome liquid crystal display screen use is made of a continuous phosphor layer, which comprises a mixture of a red and a green phosphor and transmits a part of the blue light from the radiation source. As a result, a wide color dot is obtained.

The pixels may be bordered by a black matrix 12, which serves to improve the contrast and the color purity.

The contrast at ambient light conditions can also be improved by coloring the front substrate 3.

In operation, a voltage is applied, in accordance with the desired picture, between the two electrode arrays. In the part of the liquid crystal layer situated between turned-off switching points, the liquid crystal molecules exhibit a twisted structure with a 90° rotation across the cross-section of the cell. In the part of the liquid crystal layer situated between turned-on switching points, the liquid crystal molecules exhibit a straight structure without, or substantially without, a rotation across the cross-section of the cell.

The unpolarized blue radiation having a wavelength of 400 nm<λ₁<450 nm, which is generated by the mercury low-pressure lamp 7, traverses the polarizer, the liquid crystal medium and the analyzer at locations in the liquid crystal layer where no voltage is applied, and subsequently impinges in the phosphor layer on a red, green or blue pixel. The pixels in the phosphor layer are associated with the switching points of the drive and aligned therewith. The red and green phosphors excited by the blue light and the blue pigment then emit visible light in one of the colors red, green or blue.

1. A liquid crystal display screen provided with a liquid crystal layer, two parallel transparent substrates by which the liquid crystal layer is flanked, a means for influencing the transmission state of the liquid crystal layer, a blue-emitting radiation source for radiation with a maximum emission at a wavelength of 400<λ₁<450 nm at the side of the first substrate, and a first phosphor layer comprising at least one phosphor, which phosphor layer is situated on the second substrate.

2. A liquid crystal display screen as claimed in claim 1, characterized in that the blue-emitting radiation source comprises a fluorescent lamp having a blue-emitting phosphor layer.

3. A liquid crystal display screen as claimed in claim 1, characterized in that the blue-emitting radiation source comprises a blue-emitting light emitting diode.

4. A liquid crystal display screen as claimed in claim 1, characterized in that the first phosphor layer comprises a red phosphor, a green phosphor and a blue color filter.

5. A liquid crystal display screen as claimed in claim 1, characterized in that the first phosphor layer comprises o-(6-diethylamino-3-diethylimino-3H-xanthene-9-yl)benzoic acid for the red phosphor, 3-(2′-benzothiazolyl)-7-diethylaminocoumarin for the green phosphor and CoAl₂O₄ for the blue color filter.

6. A liquid crystal display screen as claimed in claim 1, characterized in that a second phosphor layer is arranged between the liquid crystal layer and the first phosphor layer.
